(19) United States
(12) Patent Application Publication
(10) Pub. No.: US 2025/0055789 A1
(43) Pub. Date: Feb. 13, 2025

(54) REAL-TIME MANAGEMENT OF SERVICE NETWORK PATHWAYS

(71) Applicant: Cisco Technology, Inc., San Jose, CA (US)

(72) Inventors: Clarence Filsfils, Brussels (BE); Syed Kamran Raza, Kanata (CA); Pablo Camarillo Garvia, Madrid (ES); Jisu Bhattacharya, San Jose, CA (US)

(21) Appl. No.: 18/629,355

(22) Filed: Apr. 8, 2024

Related U.S. Application Data
(60) Provisional application No. 63/531,652, filed on Aug. 9, 2023.
(60) Provisional application No. 63/519,205, filed on Aug. 11, 2023.

(51) Int. Cl. H04L 45/302; H04L 45/24; H04L 47/125; H04L 47/2483

(52) U.S. Cl. CPC H04L 45/308; H04L 45/24; H04L 47/125; H04L 47/2483

(57) ABSTRACT

This disclosure describes techniques and mechanisms for coupling measurement probes with customer data traffic and enabling real-time and selective management of ECMP pathways that are not meeting performance metric(s) in a service provider network. Nodes within the service provider network are configured to perform specific hashing behavior. An ingress node may be configured to create and maintain a TCAM table to store flow label(s) corresponding to ECMP pathways that are not meeting performance metric(s). The system may configure performance measurement session(s) between an ingress node and an egress node. The system may receive performance data, identify pathway(s) violating performance metric(s), and may perform action(s) in real-time.

### CROSS REFERENCE TO RELATED APPLICATIONS

This application claims priority to U.S. Provisional Patent Application No. 63/531,652, filed Aug. 9, 2023, and U.S. Provisional Patent Application No. 63/519,205, filed Aug. 11, 2023, the entire contents of which are incorporated herein by reference.

### TECHNICAL FIELD

The present disclosure relates generally to the field of computer networking, and more particularly to coupling measurement probes with customer traffic and enabling real-time and selective management of equal-cost multi-path (ECMP) pathways that are not meeting service level agreement (SLA) requirements within a service provider network.

### BACKGROUND

In service provider networks, traffic flows that are routed through network paths are expected to satisfy certain constraints as defined in customer Service Level Agreements (SLAs). For example, services such as telemedicine, online gaming, autonomous connected cars, stock market trading and many mission-critical applications have strict end-to-end constraints.

A problem that may arise in service provider networks relates to providing guaranteed extreme-level SLAs. For instance, service providers may rely on either using external probing appliances, or built-in probes in the network to build monitoring sessions that attempt to measure the end-user experience. However, because of the separation that exists today between underlay and overlay network, there is no current mechanism to ensure probe packets measure the same experience as customer data packets. For example, where there are several ECMP paths in between the source and the destination, customer data packets may be hashed into a first ECMP pathway and a probe packet may be hashed into a second, different ECMP pathway. In other words, there is no coupling between the customer and measurement packets.

Two-way active measurement protocols (TWAMP) and simple two-way active measurement protocols (STAMP) are examples of probing techniques that may be used. In TWAMP, the active measurement packets derive the flow label value using the different IP header (e.g., egress and ingress loopback addresses) compared to the customer data packets and, thus, do not follow the same equal-cost multi-path (ECMP) pathway as the customer traffic flow. For instance, a user may create probe packets that explore all the different ECMP pathways by modifying some of the packet fields (e.g., sweep the port number) such that each measurement packet is hashed by transit routers into a different path, and measure the overall experience across ECMP pathways.

However, existing techniques are insufficient given that routers may hash probe packets differently from data traffic when ECMP is detected. For instance, routers utilize outer and inner headers within a data packet when creating a hash. Given the fields and values of the outer and inner headers are different between data packet(s) and probe packet(s), routers may hash the probe packets along different ECMP pathways than the customer data packets. Thus, the probe packets provide inaccurate measurements of customer data packet experience.

Moreover, existing techniques do not provide the ability for the networking system to perform actions upon poor SLA detection during measurement sessions. For instance, current techniques may re-route traffic once an end host detects a pathway has an SLA violation, and thus does not apply to external routers.

Accordingly, there is a need to provide a mechanism to enable probe packets to measure the same experience as customer data packets and provide the ability to react and steer traffic when pathways within a network are not meeting performance metrics.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a system can couple measurement probes with customer traffic and enable real-time and selective management of ECMP pathways that are not meeting SLA requirements.

FIG. 2 illustrates a component diagram of an example controller, as described in FIG. 1.

FIGS. 3A-3C illustrate exemplary encapsulated data packets and encapsulated probe packets that may be output by the system described in FIGS. 1 and 2.

FIG. 4 illustrates a flow diagram of an example method for real-time and selective management of ECMP pathways that are not meeting SLA requirements, associated with the systems described in FIGS. 1-3.

FIG. 5 illustrates a flow diagram of an example method for performing real-time and selective management of ECMP pathways that are not meeting SLA requirements, associated with the systems described in FIGS. 1-4.

FIG. 6 is a computer architecture diagram showing an illustrative computer hardware architecture for implementing a device that can be utilized to implement aspects of the various technologies presented herein.

### DESCRIPTION OF EXAMPLE EMBODIMENTS

### Overview

The present disclosure relates generally to the field of computer networking, and more particularly to coupling measurement probes with customer traffic and enabling real-time and selective management of equal-cost multi-path (ECMP) pathways that are not meeting service level agreement (SLA) requirements within a service provider network.

A method to perform the techniques described herein may include sending, to an ingress node and an egress node within the network, a first instruction to configure a performance measurement session for a first pathway between the ingress node and the egress node. The method may include receiving, from the egress node and at a first time, first performance data associated with the first pathway, the first performance data including a first flow label. The method includes determining, based at least in part on the first performance data, that the first pathway is violating a performance metric. The method also includes sending, to the ingress node, a second instruction to encapsulate a subsequent data packet that includes the first flow label using a second flow label that corresponds to a second pathway that complies with the performance metric.

Another method to perform the techniques described herein may include receiving, by a first node of a network and via a first pathway, a data packet associated with a customer data flow. The method also includes hashing, by the first node, an outer header of the data packet to generate a flow label associated with the data packet. Additionally, the method includes determining, by the first node, that the flow label matches a stored flow label associated with an entry in a table maintained by the first node, the stored flow label indicating the first pathway violates a performance metric. The method includes based at least in part on determining that the flow label matches the stored flow label: identifying a second pathway that complies with the performance metric; and identifying an updated flow label. The method also includes performing, by the first node, encapsulation of the data packet that includes encoding the updated flow label into the outer header of the data packet. The method further includes sending, by the first node and to a second node, the data packet via the second pathway.

Additionally, any techniques described herein, may be performed by a system and/or device having non-transitory computer-readable media storing computer-executable instructions that, when executed by one or more processors, performs the method(s) described above and/or one or more non-transitory computer-readable media storing computer-readable instructions that, when executed by one or more processors, cause the one or more processors to perform the method(s) described herein.

### EXAMPLE EMBODIMENTS

In a service provider network, traffic flows that are routed through network paths are expected to satisfy certain constraints as defined in customer Service Level Agreements (SLAs). For example, services such as telemedicine, online gaming, autonomous connected cars, stock market trading and many mission-critical applications have strict end-to-end constraints.

A problem that may arise in service provider networks relates to providing guaranteed extreme-level SLAs. For instance, service providers may rely on either using external probing appliances, or built-in probes in the network to build monitoring sessions that attempt to measure the end-user experience. However, due to the separation that exists today between underlay and overlay networks, there is no current mechanism to enable probe packets to measure the same experience as customer data traffic.

For example, where there are several ECMP paths in between the source and the destination, it is likely that the user traffic is hashed into a particular ECMP path that is not the one been experienced by the probe. In other words, there is no coupling between the customer and measurement packets.

As noted above, existing techniques are insufficient. For instance, routers in a service provider network may hash the probe packets differently from data traffic when ECMP presence is detected. For instance, each router within a network includes a load-balancing vector used to build the load balancing keys in hardware of the networking device(s) (e.g., routers, switches, etc.). The load balancing keys are used by the router(s) to hash the data traffic (e.g., data packet(s)) and the probe packets. In particular, the load balancing keys contain fields of the Level 3 and Level 4 (L4) headers of an outer encapsulating header of the probe packet or data traffic, as well as fields of the L3 and L4 headers of the inner packet headers. That is, the router(s) currently hash data packet(s) and probe packet(s) using values of the outer headers and the inner headers of packet(s). Therefore, even if the exact same encapsulation is applied to a probe packet and a data packet, those two packets will be hashed differently by transit routers within the service provider network. Thus, the two packets will be sent using different pathways. This is applicable regardless of whether an external probing appliance is used or whether the user generates probe packets from the ingress routers (i.e., built-in performance measurement). Accordingly, the probe packets provide inaccurate measurements of customer data packet experience.

Moreover, existing techniques do not provide the ability for the networking system to perform actions upon poor SLA detection during measurement sessions. For instance, current techniques may re-route traffic upon detecting an SLA violation of a pathway, however, re-routing may not provide stability. Further, current re-routing techniques may re-route traffic once an end host detects a pathway has an SLA violation, and thus does not apply to external routers.

Accordingly, there is a need to provide a mechanism to enable probe packets to measure the same experience as customer data packets and provide the ability to react and steer traffic when pathways within a network are not meeting performance metrics.

This disclosure describes techniques and mechanisms for passive measurement for coupling measurement probes with customer traffic and enabling real-time and selective management of ECMP pathways that are not meeting SLA requirements. The techniques may be implemented by a controller and may include sending, to an ingress node and an egress node within the network, a first instruction to configure a performance measurement session for a first pathway between the ingress node and the egress node. The techniques may include receiving, from the egress node and at a first time, first performance data associated with the first pathway, the first performance data including a first flow label. The techniques may include determining, based at least in part on the first performance data, that the first pathway is violating a performance metric. The techniques may also include sending, to the ingress node, a second instruction to encapsulate a subsequent data packet that includes the first flow label using a second flow label that corresponds to a second pathway that complies with the performance metric.

The techniques may also be implemented by node(s) of a service provider network. The techniques may include receiving, by a first node of a network and via a first pathway, a data packet associated with a customer data flow. The techniques may include hashing, by the first node, an outer header of the data packet to generate a flow label associated with the data packet. Additionally, the techniques include determining, by the first node, that the flow label matches a stored flow label associated with an entry in a table maintained by the first node, the stored flow label indicating the first pathway violates a performance metric. Further, techniques include based at least in part on determining that the flow label matches the stored flow label: identifying a second pathway that complies with the performance metric; and identifying an updated flow label. The techniques may also include encoding, by the first node, the updated flow label into the outer header of the data packet. The techniques may include sending, by the first node and to a second node, the data packet via the second pathway.

In some examples, the controller may comprise a configuration module. In some examples, the configuration module is configured to communicate with nodes within a service provider network. For instance, the configuration module may configure all the routers in the service provider network to use a mechanism for consistent ECMP hashing. In some examples, the mechanism includes sending instructions to configure hardware of each router to perform an action based on whether a fixed header bit of a data packet is set or not. For instance, based on the notion of the Structured Flow Label [1], the controller may configure the routers (e.g., nodes) to define one bit in the Flow Label (e.g., the Fixed Header (FH) bit), to signal to all the downstream routers up to perform specific behavior when computing the hash value for the data packet. For example, the instructions may configure the node(s) to perform existing hashing behavior where the FH bit is unset (e.g., is set to “0”). Where the FH bit is set (e.g., is set to “1”), the nodes may be configured to mask all the fields in the load balancing vector except for one or more fields of the IPV6 outer header before computing the load balancing keys described herein. For instance, in one example, where the FH bit is set, the transit routers may be configured by controller to ignore the fields of any header (outer or inner) except for the IPV6 flow label, for the purpose of building the LB-keys. In some examples, where the FH bit is set, the transit routers may be configured by the controller to ignore the fields of the inner headers, as well as one or more fields of the IPV6 outer header (e.g., such as the next header (NH) field). In this example, the transit routers may utilize the IPV6 flow label, IPv6 source address, and/or the IPV6 destination address for the purposes of building the LB-keys. By configuring the routers to mask all other fields except for the field(s) of the IPV6 outer header (e.g., such as the flow label, source address, and/or destination address), the controller may ensure that the transit nodes in the network perform hashing using the IPV6 field(s), thereby ensuring that there is consistent hashing across both customer data packets and measurement probing packets.

In some examples, the configuration module further configures an ingress node within the service provider network. For instance, the configuration module may configure the ingress node to use 12 bits of the flow label for entropy purposes. In doing so, the controller may limit the number of monitoring sessions that must be configured. Thus, when a performance measurement session is configured, the 12 least significant bits of the flow label may be used to sweep through all the flow label values and/or ECMP pathways. As an example, by limiting the ingress node to using 12 bits of the flow label (instead of the full 20 bit size of the flow label), 4,000 different performance measurement sessions may be configured and/or occur simultaneously, where each performance measurement session may correspond to a different flow label value and/or a different ECMP pathway. Thus, every flow label value within the service provider network may be monitored by the controller. In some examples, the configuration module may configure the ingress node to generate IPV6 packets of customer data packets that include the fixed header bit of the flow label field being set, where the customer data packets are associated with a data flow that has one or more particular SLA requirements (e.g., guaranteed SLA, etc.). In some examples, the configuration module may configure the ingress node to generate encapsulated probe packet(s) for measurement session(s) associated with one or more customer data flow(s) that have a particular SLA requirement.

The configuration module may further configure the ingress node to create and maintain a ternary content-addressable memory (TCAM) table and the ingress node data plane. For instance, the configuration module may provide instructions to the ingress node that enables the ingress node to create, maintain (e.g., add new entries, remove entries, etc.), and perform operations on the TCAM table.

In some examples, the controller may comprise a performance module. In some examples, the performance module is configured to monitor the performance measurement session(s). For instance, the performance module may be configured to retrieve (e.g., query, pull, etc.), from an egress node of the service provider network, for performance data associated with each of the performance measurement sessions. In some examples, the performance module may be configured to retrieve the performance data at particular time intervals (e.g., every second, every 5 seconds, every 30 seconds, every minute, every 2 minutes, etc.). In some examples, the performance module may be configured to determine whether a performance metric is violated in association with one or more of the pathways. For instance, the performance module may determine, based on the performance data, that a first pathway is experiencing packet loss, delay, etc. that violates a SLA requirement of the first pathway. In this example, the performance module may further identify, from the remaining pathways and performance measurement sessions, a second pathway that is compliant with performance metrics. The performance module may output an indication of the pathway in violation of the SLA requirement and/or an indication of the second pathway that complies with the performance metrics to the controller.

In some examples, the performance module may be configured to maintain the measurement session associated with the pathway that violates the performance metric. For instance, the performance module may keep monitoring the pathway and/or send probing packet(s) along the pathway. The performance module may determine, based on the performance data, that a pathway that was previously violating the SLA requirement, now complies with the SLA requirement (e.g., the pathway is no longer underperforming, experiencing delay, experiencing loss, etc.). The performance module may output an indication of the pathway that has come back within compliance of the SLA requirement to the controller.

In some examples, the controller may be configured to communicate with the ingress module for real-time updating of the TCAM table. For instance, where the performance module determines that the first pathway violates the SLA requirement (or other performance metric), the controller and/or performance module may send, to the ingress node, instructions to create a new entry within the TCAM table that contains the flow label value corresponding to the first pathway that is not meeting the performance metric. The controller and/or performance module may also identify a second flow label value associated with the second pathway that complies with the performance metric(s). The controller and/or performance module may instruct the ingress module to use the second flow value to encapsulate any future data packets that are received and are hashed to the value of the first flow label.

In some examples, such as where the performance module determines that a pathway that was in violation of a performance metric is now compliant, the controller and/or performance module may send instructions to the ingress module that identify the flow label value associated with the pathway and instruct the ingress module to remove (e.g., delete) the entry in the TCAM table associated with the flow label value.

In some examples, the system may include techniques for coupling measurement probes with customer traffic. In some examples, the system may comprise an ingress node. In some examples, the ingress node may comprise one or more of a hashing module, an encapsulation module, and/or a ternary content-addressable memory (TCAM) module.

In some examples, the hashing module is configured to perform hashing of data packets (e.g., customer data packets and/or probe packets (also referred to herein as measurement packets or measurement probes)). For instance, when the ingress node receives a data packet, the hashing module may perform and/or compute a hash value (e.g., a flow label value). In some examples, the hash value may be computed using a 5-tuple or any other suitable mechanism. In some examples, the hashing module may output the hash value to the TCAM module. In some examples, the hashing module also identifies the destination of the packet and looks at where it will be sent (e.g., from branch A to branch B for VPNs) and may output the destination to the encapsulation module and/or the TCAM module.

In some examples, the TCAM module is configured to create and manage a TCAM table. In some examples, the TCAM table comprises a 3-state TCAM. In some examples, the TCAM module maintains entries associated with poisoned flow labels. As used herein, the term “poisoned flow label” or “poisoned flow labels” corresponds to a flow label that is routed along a pathway that violates a performance metric (e.g., SLA pathway requirement or other network performance requirement). In some examples, the TCAM table may comprise a plurality of entries. For instance, when the ingress node receives an instruction to create a new entry in the TCAM table, the TCAM module may create the entry and store the corresponding flow label value associated with the pathway that violates one or more performance metric(s). In some examples, the TCAM module may further store indication(s) of alternative pathway(s) to use in association with each of the poisoned flow labels. For instance, the alternative pathway identified for a first entry in the TCAM table may be different from a second alternative pathway identified for a second entry in the TCAM table. In some examples, an alternative pathway identified for the first entry may be the same as one or more other entries within the TCAM table. In some examples, the TCAM module may be configured to delete and/or remove entries from the TCAM table, such as in response to receiving instructions from the controller. In some examples, the TCAM module may create entries, perform lookup operation(s), and delete entries in real-time.

In some examples, the TCAM module is configured to receive the hash value from the hashing module and perform a lookup operation within the TCAM table. For instance, when the ingress node receives a customer data packet, the ingress node may identify whether the hash value matches any of the stored poisoned flow label values. Where the TCAM module determines there is a match to one of the entries, the TCAM module may identify the alternative pathway associated with the particular entry. In this example, the TCAM module may output an alternative flow label value associated with the alternative pathway to the encapsulation module. Where the TCAM module determines that the hash value does not match any of the entries within the TCAM table, the TCAM module may output the hash value to the encapsulation module.

In some examples, the encapsulation module is configured to encapsulate customer data packet(s) and/or measurement probe packet(s) using SRv6 encapsulation. For instance, the encapsulation module may receive the hash value (or alternative flow label value) and/or destination address and may use the hash value (or alternative flow label value) to build an outer encapsulation. The outer encapsulation is an IPV6 header that includes a source address, a destination address, and a flow label (e.g., resulting bits of the hash value of the data packet). In some examples, the IPV6 outer header is used by the nodes within the service provider network to route traffic through the service provider network (e.g., such as by using the FH bit in the flow label). In some examples, the outer IPv6 header comprises a source address (e.g., the ingress node where data packet was injected into the service provider network), a destination address (where is the egress node that the data packet is going to), a flow label field (e.g., includes the FH bit, entropy information, flow label values, etc.), a next header field, etc., In some examples, one or more of the IPV6 source address, IPv6 destination address, and/or IPv6 flow label field are used by transit routers in the service provider network to perform the load balancing. Accordingly, when building the outer encapsulation, the encapsulation module may utilize the flow label to dictate routing of the data packets through the service provider network.

As noted above, one or more nodes (e.g., the ingress node, transit node(s), and the egress node(s)) within the service provider network may be configured to perform specific hashing operations based on the FH bit value being unset or set. Accordingly, the encapsulation module of the ingress node may be configured to determine whether the value of the FH bit should be set or unset. In some examples, the encapsulation module may set or unset the FH bit value in response to receiving instructions from the controller (e.g., such as instructions to configure performance measurement session(s), sampling of customer data packet(s), etc.). In some examples, the FH bit value may be set (e.g., equal to “1” or any other suitable value) for all customer data traffic or portion(s) of the customer data traffic. In some examples, the FH bit value may be set for all probe packet(s) or portion(s) of the probe packet(s). While the examples described herein relate to signaling to transit router(s) using the fixed header bit value, it is understood that the system may signal in other ways, using other header(s), value(s), and/or other signaling techniques.

As an example, a system may comprise 100 pathways between an ingress node and an egress node. Using the techniques described herein the system may detect that a pathway (e.g., such as pathway 43) is not performing adequately (e.g., not meeting a required SLA, latency above a threshold, jitter above a threshold, loss above a threshold, etc.), resulting in performance degradation. In this example and using the techniques described herein the system may configures the transit nodes to steer all traffic flows (e.g., data packets and/or probe packet(s)) which are hashed into pathway 43 to a different pathway that does not experience performance degradation in real-time. Further the system may maintain (e.g., keep active) the remaining pathways (e.g., pathways 1-42 and 44-100) which are acting correctly.

In this way the system enables a controller to (i) measure the experience of user traffic with improved accuracy and (ii) steer the traffic of the affected users in real-time from the affected pathway to a different path that does not experience performance degradation. That is, by configuring hardware of node(s) within the service network to perform specific hashing when a fixed header bit is set, the system may ensure measurement packets and customer traffic are sent via the same pathways. Moreover, by configuring ingress nodes to create and perform a new behavior at the ingress node data plane (e.g., create and maintaining the poisoned flow label TCAM table), the system may enable selective and real-time removal of pathways that violate performance metrics and utilization of other pathways, along the same route, that meets performance metrics.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

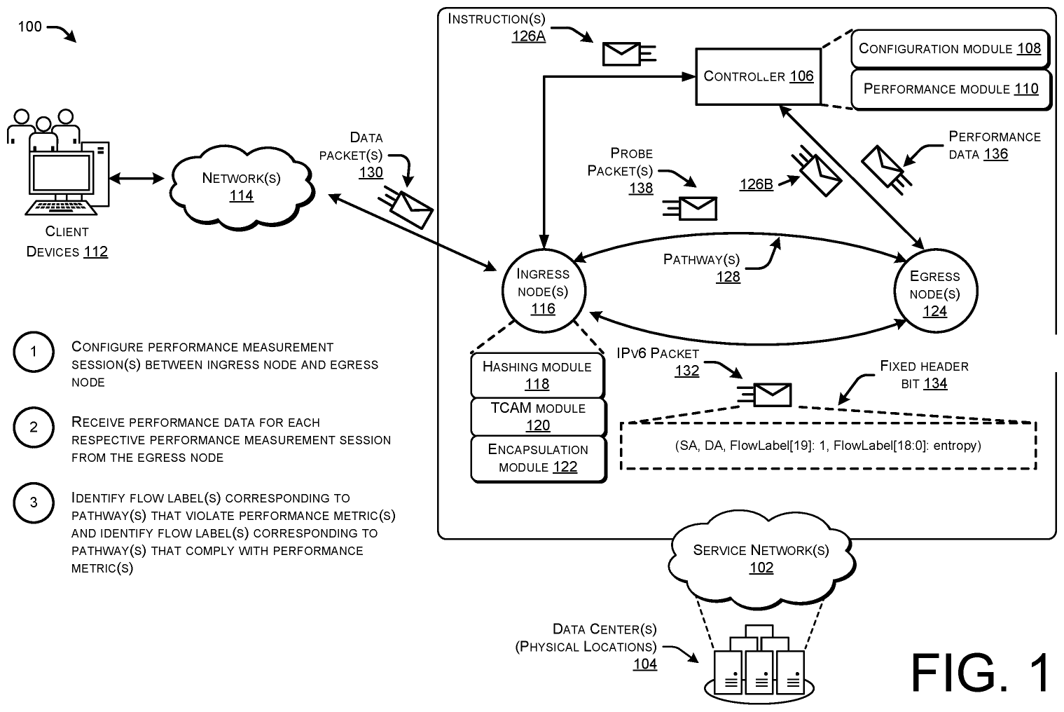

FIG. 1 illustrates a system-architecture diagram of an environment in which a system 100 can couple measurement probes with customer traffic and enable real-time and selective management of ECMP pathways that are not meeting SLA requirements.

The system 100 may include service network(s) 102. The service network(s) 102 may include one or more networks implemented by any viable communication technology, such as wired and/or wireless modalities and/or technologies. The service network(s) 102 may include any combination of Personal Area Networks (PANs), software defined cloud interconnects (SDCI), Local Area Networks (LANs), virtual private networks (VPNs), software defined networks (SDNs), Campus Area Networks (CANs), Metropolitan Area Networks (MANs), extranets, intranets, the Internet, short-range wireless communication networks (e.g., ZigBee, Bluetooth, etc.), Wide Area Networks (WANs)—both centralized and/or distributed, software defined WANs (SD-WANs—and/or any combination, permutation, and/or aggregation thereof. The service network(s) 102 may include devices, virtual resources, or other nodes that relay packets from one network segment to another by nodes in the computer network. The service network(s) 102 may include multiple devices that utilize the network layer (and/or session layer, transport layer, data plane layer, etc.) in the OSI model for packet forwarding, and/or other layers.

In some examples, the service network(s) 102 may comprise one or more data center(s) 104. The data center(s) 104 may include devices housed or located in one or more locations. The data center(s) 104 may be physical facilities or buildings located across geographic areas that designated to store networked devices that are part of a manufacturer. The data center(s) 104 may include various network devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples the devices in the packet-forwarding networks may not be located in explicitly defined data centers, but may be located in other locations or buildings. In some examples, the site(s) comprise network device(s), which may correspond to any computing device, routers, switches, computers, or any other type of network device.

The system 100 may comprise network(s) 114. The network(s) 114 may be used by client device(s) 112 to access the service provider network(s) 102. The network(s) 114 may include one or more networks implemented by any viable communication technology, such as wired and/or wireless modalities and/or technologies. The network(s) 114 may include any combination of Personal Area Networks (PANs), VPNs, SDNs, SD-WANs, Local Area Networks (LANs), Wireless LANs, Campus Area Networks (CANs), Metropolitan Area Networks (MANs), extranets, intranets, the Internet, short-range wireless communication networks (e.g., ZigBee, Bluetooth, etc.), Wide Area Networks (WANs)—both centralized and/or distributed—and/or any combination, permutation, and/or aggregation thereof. The network(s) 114 may include devices, virtual resources, or other nodes that relay packets from one network segment to another by nodes in the computer network. The network(s) 114 may include multiple devices that utilize the network layer (and/or session layer, transport layer, etc.) in the OSI model for packet forwarding, and/or other layers.

The system 100 may comprise a controller 106. In some examples, the controller 106 corresponds to a system that has complete visibility into the security fabric of a given network (e.g., enterprise network, smaller network, etc.). In some examples, the controller 106 may comprise a memory, one or more processors, etc., In some examples, the controller 106 may comprise a routing controller. In some examples, the controller 106 corresponds to a centralized controller within the service provider network(s) 102. The controller 106 may be configured to communicate with one or more nodes (e.g., ingress node(s) 116, transit node(s) (not shown), egress node(s) 124, etc.).

In some examples, the controller 106 comprises a configuration module 108. In some examples, the configuration module is configured to communicate with all the nodes within a service provider network 102. For instance, the configuration module may configure each router (e.g., node) in the service provider network to use a mechanism for consistent ECMP hashing. In some examples, the mechanism includes sending instructions to configure hardware of each router to perform an action based on whether a fixed header bit of a data packet is set or not. For instance, based on the notion of a Structured Flow Label [1], the controller may configure the routers (e.g., nodes) to define one bit in the Flow Label (e.g., the Fixed Header (FH) bit), to signal to all the downstream routers (e.g., transit node(s) and/or the egress node) up to perform specific behavior when computing the hash value for the data packet. For example, the instructions may configure the node(s) to perform existing hashing behavior where the FH bit is unset (e.g., is set to “0”). As noted above, each router within a network includes a load-balancing vector used to build the load balancing keys in hardware of the networking device(s) (e.g., routers, switches, etc.). The load balancing keys are used by the router(s) to hash the data traffic (e.g., data packet(s)) and the probe packets. In particular, the load balancing keys contain fields of the Level 3 and Level 4 (L4) headers of an outer encapsulating header of the probe packet or data traffic, as well as fields of the L3 and L4 headers of the inner packet headers. That is, the router(s) currently hash data packet(s) and probe packet(s) using values of the outer headers and the inner headers of packet(s). Thus, when the FH bit is unset (e.g., equal to “0”), the nodes of the service provider network may continue to perform this behavior.

Where the FH bit is set (e.g., is set to “1”), the nodes may be configured to mask all the fields in the load balancing vector except for one or more field(s) of the IPV6 outer header. For instance, in some examples, all fields of the inner headers and all fields of the outer IPv6 header (e.g., such as the IPV6 SA, IPV6 DA, and/or NH) except for the IPV6 Flow Label field are masked before computing the load balancing keys described herein. In some examples, all fields of the inner headers and one or more fields of the outer IPV6 header (e.g., the NH field) except for the IPV6 Flow Label field, IPV6 SA, and/or IPv6 DA, are masked before computing the load balancing keys described herein. In other words, where the FH bit is set, the routers may be configured by controller to ignore all fields of the inner headers and one or more fields of the outer IPv6 header, for the purpose of building the LB-keys. By configuring the routers to mask field(s) of the inner and outer headers, the controller 106 may ensure that the transit nodes in the network perform hashing using the same fields of the IPV6 header that remain unchanged between customer data packets and probe packets, thereby ensuring that there is consistent hashing across both IPv6 packets 132 and probe packets 138.

In some examples, the configuration module 108 further configures an ingress node 116 within the service provider network 102. For instance, the configuration module may send instruction(s) 126A that configure the ingress node to use 12 bits of the flow label value for entropy purposes. In doing so, the controller 106 may limit the number of measurement sessions that are configured, when requested. Thus, when a performance measurement session is configured, the ingress node 116 may use the 12 least significant bits of the flow label value to sweep through all the flow label values and/or ECMP pathways within the service provider network 102. As an example, by limiting the ingress node 116 to using 12 bits of the flow label (instead of the full 20 bit size of the flow label), 4,000 different performance measurement sessions may be configured and/or occur simultaneously, where each performance measurement session may correspond to a different flow label value and/or a different ECMP pathway. Thus, every flow label value within the service provider network may be monitored by the controller 106.

The configuration module 108 may further configure the ingress node to create and maintain a ternary content-addressable memory (TCAM) table and the ingress node data plane. For instance, the configuration module 108 may provide instructions 126A to the ingress node 116 that enables the ingress node to create, maintain (e.g., add new entries, remove entries, etc.), and perform operations on the TCAM table.

In some examples, the controller 106 comprises performance module 110. In some examples, the performance module 110 is configured to monitor the performance measurement session(s). For instance, the performance module 110 may be configured to retrieve (e.g., query, pull, etc.), from an egress node 124 of the service provider network 102, for performance data 136 associated with each of the performance measurement sessions. In some examples, the performance module 110 may be configured to retrieve the performance data at particular time intervals (e.g., every second, every 5 seconds, every 30 seconds, every minute, every 2 minutes, etc.). In some examples, the performance module may be configured to determine whether a performance metric is violated in association with one or more of the pathway(s) 128. For instance, the performance module may determine, based on the performance data, that a first pathway is experiencing packet loss, delay, etc., which violates a SLA requirement of the first pathway. In this example, the performance module may further identify, from the remaining pathways and performance measurement sessions, a second pathway that is compliant with performance metrics (e.g., has latency less than a threshold, packet loss less than a threshold, is meeting a guaranteed SLA of the particular flow, etc.). The performance module may output an indication of the pathway in violation of the SLA requirement and/or an indication of the second pathway that complies with the performance metrics to the controller.

For example, a performance measurement session may be set up between an ingress node (“A”) and an egress node (“B”). In this example, there are a plurality of ECMP pathways from A to B. For instance, there may be 10 ECMP pathways from A to B, such that 10 measurement sessions are configured from A to B. In this example, each measurement session is hashed into each of the 10 ECMP pathways. In some examples, mapping of each measurement session to a respective pathway may be performed using path tracing techniques. In this example, the performance module may pull performance data for each of the pathways periodically (e.g., every second). The performance module may measure the SLA from A to B on a per ECMP pathway basis. In some examples, the performance module may determine that MS (A,B, Pathway1) (e.g., a first pathway of a measurement session measuring A to B) is exceeding a SLA (e.g., experiencing above a threshold loss, threshold latency, jitter, etc.) that results in network degradation, then the performance module may walkthrough the remaining pathways and measurement session(s) (e.g., MS (A,B, PathwayX). Where the performance module determines that one of the remaining pathway(s) and measurement session(s) is within the SLA (e.g., such as pathway X), the performance module may identify the flow label value associated with pathway X and instruct the ingress node to rehash pathway 1 into pathway X by adding the flow label value of pathway 1 to the TCAM table and sending the flow label value of pathway X for use. In some examples, such as where the performance module does not identify another pathway that is within the SLA requirements, the performance module may instruct the ingress module to reroute the packets through the network (e.g., via a different router, etc.).

In some examples, the performance module 110 may be configured to maintain the measurement session associated with the pathway that violates the performance metric. For instance, the performance module may keep monitoring the pathway and/or send probing packet(s) along the pathway. The performance module may determine, based on the performance data, that a pathway that was previously violating the SLA requirement, now complies with the SLA requirement (e.g., the pathway is no longer underperforming, experiencing delay, experiencing loss, etc.). The performance module may output an indication of the pathway that has come back within compliance of the SLA requirement to the controller.

In some examples, the controller 106 may be configured to communicate with the ingress module for real-time updating of the TCAM table. For instance, where the performance module determines that the first pathway violates the SLA requirement (or other performance metric), the controller and/or performance module may send, to the ingress node, instructions to create a new entry within the TCAM table that contains the flow label value corresponding to the first pathway that is not meeting the performance metric. The controller 106 and/or performance module 110 may also identify a second flow label value associated with the second pathway that complies with the performance metric(s). The controller and/or performance module may instruct the ingress module to use the second flow value to encapsulate any future data packets that are received and hash to the value of the first flow label.

In some examples, such as where the performance module 110 determines that a pathway that was in violation of a performance metric is now compliant, the controller and/or performance module may send instructions 126A to the ingress module that identify the flow label value associated with the pathway and instruct the ingress module to remove (e.g., delete) the entry in the TCAM table associated with the flow label value.

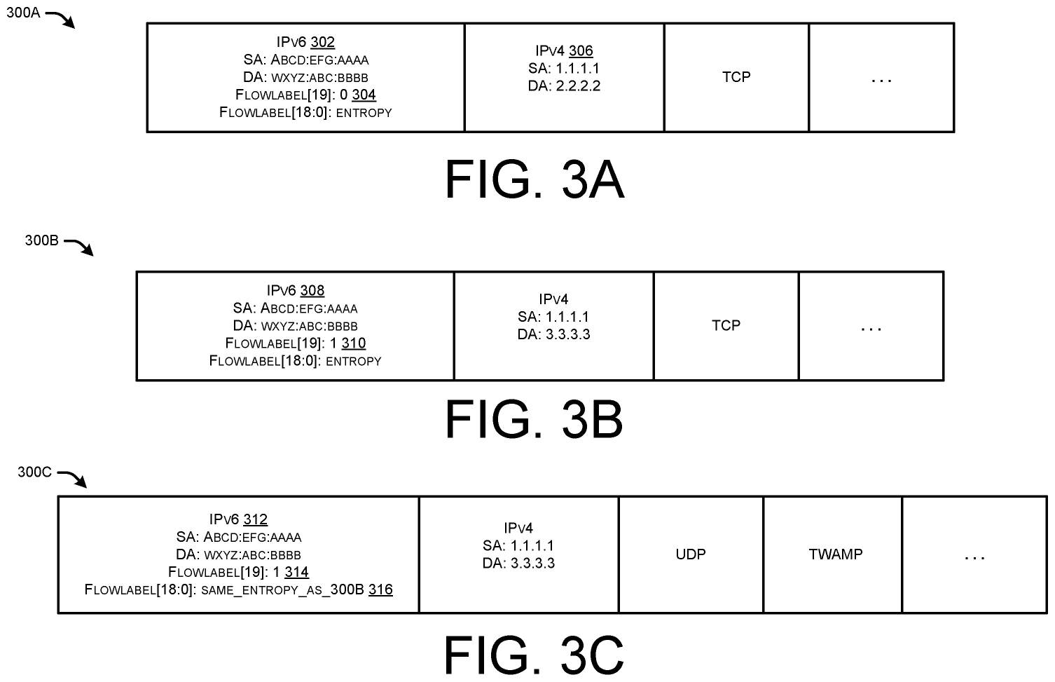

In some examples, the controller 106 may send instruction(s) 126A to the ingress node to configure one or more measurement session(s). For instance, the instruction(s) 126A may cause the ingress node 116 to generate IPv6 packets of data packets 130 that include the fixed header bit of the flow label field being set, where the customer data packets are associated with a data flow that has one or more particular SLA requirements (e.g., guaranteed SLA, etc.). In some examples, the controller 106 may further instruct the ingress node 116 to generate encapsulated probe packet(s) 138 for the measurement session(s) that are created and/or encapsulated based on the IPV6 packet(s) 132. For instance, the instruction(s) 126A may identify a particular data flow of a client device 112 that has a particular SLA requirement and instruct the ingress node to configure measurement session(s) associated with data packet(s) 130 of the particular data flow. The ingress node 116 may configure the measurement session(s), generate IPv6 packet(s) 132, and generate probe packet(s) 138 (e.g., such as encapsulated probe packet 300C, described in greater detail in FIG. 3C below).

In some examples, the controller 106 may be configured to send instructions 126B to egress node(s) 124. In some examples, the instruction(s) 126B may correspond to configuration instructions (as described above). In some examples, the instruction(s) 126B may comprise queries for performance data 136. In some examples, the performance data 136 corresponds to packet data associated with probe packet(s) (e.g., such as probe packet(s) 138) that are injected and/or created at the ingress node(s) 116 during the performance measurement session(s).

In some examples, the ingress node(s) 116 may comprise a hashing module 118. In some examples, the hashing module 118 is configured to perform hashing of data packets (e.g., customer data packets and/or probe packets (also referred to herein as measurement packets or measurement probes)). For instance, when the ingress node receives a data packet, the hashing module may compute a hash value (e.g., a flow label value) based on a portion of the data packet. In some examples, the hash value may be computed using a 5-tuple or any other suitable mechanism. In some examples, the hashing module may output the hash value to the TCAM module. In some examples, the hashing module also identifies the destination of the packet and looks at where it will be sent (e.g., from branch A to branch B for VPNs) and may output the destination to the encapsulation module and/or the TCAM module.

In some examples, the ingress node(s) 116 may comprise a TCAM module 120. the TCAM module 120 may be configured to create and manage a TCAM table. In some examples, the TCAM table comprises a 3-state TCAM. In some examples, the TCAM module maintains entries associated with poisoned flow labels. As used herein, the term “poisoned flow label” or “poisoned flow labels” corresponds to a flow label that is routed along a pathway that violates a performance metric (e.g., SLA pathway requirement (e.g., guaranteed SLA, loss, latency, jitter, etc.) or other network pathway performance requirement). In some examples, the TCAM table may comprise a plurality of entries. For instance, when the ingress node receives an instruction to create a new entry in the TCAM table, the TCAM module may create the entry and store the corresponding flow label value associated with the pathway that violates one or more performance metric(s). In some examples, the TCAM module may further store indication(s) of alternative pathway(s) to use in association with each of the poisoned flow labels. For instance, the alternative pathway identified for a first entry in the TCAM table may be different from a second alternative pathway identified for a second entry in the TCAM table. In some examples, an alternative pathway identified for the first entry may be the same as one or more other entries within the TCAM table. In some examples, the TCAM module may be configured to delete and/or remove entries from the TCAM table, such as in response to receiving instructions from the controller. In some examples, the TCAM module may create entries, perform lookup operation(s), and delete entries in real-time.

In some examples, the TCAM module 120 is configured to receive the hash value from the hashing module and perform a lookup operation within the TCAM table. For instance, when the ingress node receives a customer data packet, the ingress node may identify whether the hash value matches any of the stored poisoned flow label values. Where the TCAM module determines there is a match to one of the entries, the TCAM module may identify the alternative pathway associated with the particular entry. In this example, the TCAM module may output an alternative flow label value associated with the alternative pathway to the encapsulation module 122. Where the TCAM module 120 determines that the hash value does not match any of the entries within the TCAM table, the TCAM module may output the hash value to the encapsulation module 122.

In some examples, the ingress node(s) 116 may comprise an encapsulation module 122. The encapsulation module 122 may be configured to encapsulate data packet(s) 130 associated with customer data traffic and/or measurement probe packet(s) (not illustrated) using SRv6 encapsulation. In some examples, the data packet(s) 130 may include IPv4 encapsulation when received by the ingress node(s) 116, such that the ingress node(s) 116 may perform SRv6 encapsulation. For instance, the encapsulation module may receive the hash value (or alternative flow label value) and/or destination address and may use the hash value (or alternative flow label value) to build an outer encapsulation. The outer encapsulation is an IPv6 header that includes a source address, a destination address, and a flow label (e.g., resulting bits of the hash value of the data packet). In some examples, the IPV6 outer header is used by the nodes within the service provider network to route traffic through the service provider network (e.g., such as by using the FH bit in the flow label). In some examples, the outer IPv6 header comprises a source address (e.g., the ingress node where data packet was injected into the service provider network), a destination address (where is the egress node that the data packet is going to), and a flow label field (e.g., includes the FH bit, entropy information, flow label values, etc.). In some examples, the flow label field is used by intermediate routers in the service provider network to perform the load balancing. Accordingly, when building the outer encapsulation, the encapsulation module may utilize the flow label field to dictate routing of the data packets 130, probe packet(s), and/or IPv6 packet(s) through the service provider network.

As noted above, one or more node(s) (e.g., the ingress node, transit node(s), and/or the egress node(s)) within the service provider network may be configured to perform specific hashing operations based on the FH bit value being unset or set. Accordingly, the encapsulation module 122 of the ingress node may be configured to determine whether the value of the FH bit should be set or unset. In some examples, the encapsulation module 122 may set or unset the FH bit value in response to receiving instructions from the controller (e.g., such as instructions to configure performance measurement session(s), sampling of customer data packet(s), etc.). In some examples, the FH bit value may be set (e.g., equal to “1” or any other suitable value) for all customer data traffic or portion(s) of the customer data traffic. In some examples, the FH bit value may be set for all probe packet(s) or portion(s) of the probe packct(s).

The ingress node(s) 116 may be configured to communicate with the egress node(s) 124 via pathway(s) 128. For instance, the ingress node(s) 116 may send the IPv6 packet 132 to the egress node(s) 124 via pathway(s) 128. While not illustrated, the IPv6 packet 132 may route through one or more transit node(s) between the ingress node(s) 116 and the egress node(s) 124. As illustrated, the IPv6 packet 132 may comprise a fixed header bit 134 in an outer header. In the illustrated system, the fixed header bit 134 (e.g., “FlowLabel [19]: 1”) is set to the value of “1”, indicating to the transit node(s) to perform the new hashing behavior.

The egress node(s) 124 may be configured to send the performance data 136 to the controller 106. The performance data 136 may comprise telemetry data (e.g., latency data, liveliness data, loss data, associated with pathway(s) 128. For instance, pathway(s) 128 may comprise ECMP pathway(s).

At “1”, the system may configure performance measurement session(s) between an ingress node and egress node. For instance, the controller may send instructions 126A to ingress node 116 to configure performance measurement session(s).

At “2”, the system may receive performance data for each respective performance measurement session from the egress node. For instance, the controller 106 may receive the performance data 136 in response to queries sent to the egress node(s) 124. As described above, the performance data 136 may comprise data associated with a single pathway 128 and/or a plurality of the pathway(s) 128. In some examples, the performance data 136 comprises flow label value(s) associated with each of the pathway(s) 128.

At “3”, the system may identify flow label(s) corresponding to pathway(s) that violate performance metric(s) and flow label(s) corresponding to pathway(s) that comply with performance metric(s). For instance, the system may use performance module 110 to identify a first pathway that is not performing correctly (e.g., violating a SLA requirement, quality of service requirement, or other performance metric). As described above, the performance module 110 may also identify an alternative pathway from the remaining pathway(s) 128 that complies with performance metric(s) and the corresponding alternative flow label value.

At “4”, the system may send instruction(s) to the ingress node. For instance, the performance module may send instructions to add the flow label value associated with the pathway that is in violation of the performance metric to the TCAM table. The instructions may also include the alternative flow label value associated with the alternative pathway.

In this way the system enables a controller to (i) measure the experience of user traffic with improved accuracy (e.g., by measuring the same ECMP pathways) and (ii) may steer the traffic of the affected users in real-time, from a first pathway to a different pathway that does not experience performance degradation. That is, by configuring hardware of node(s) within the service network to perform specific hashing when a fixed header bit is set, the system may ensure measurement packets and customer traffic are sent via the same pathways. Moreover, by configuring ingress nodes to create and perform a new behavior at the ingress node data plane (e.g., create and maintaining the poisoned flow label TCAM table), the system may enable selective and real-time removal of pathways that violate performance metrics and utilization of other pathways, along the same route, that meets performance metrics. The system further provides real-time updates, such that pathway(s) previously unavailable may become available once back in compliance. Moreover, by re-hashing the data packet and/or probe packet, the system provides improved stability to the service network, as the route of the data packet and/or probe packet is unchanged.

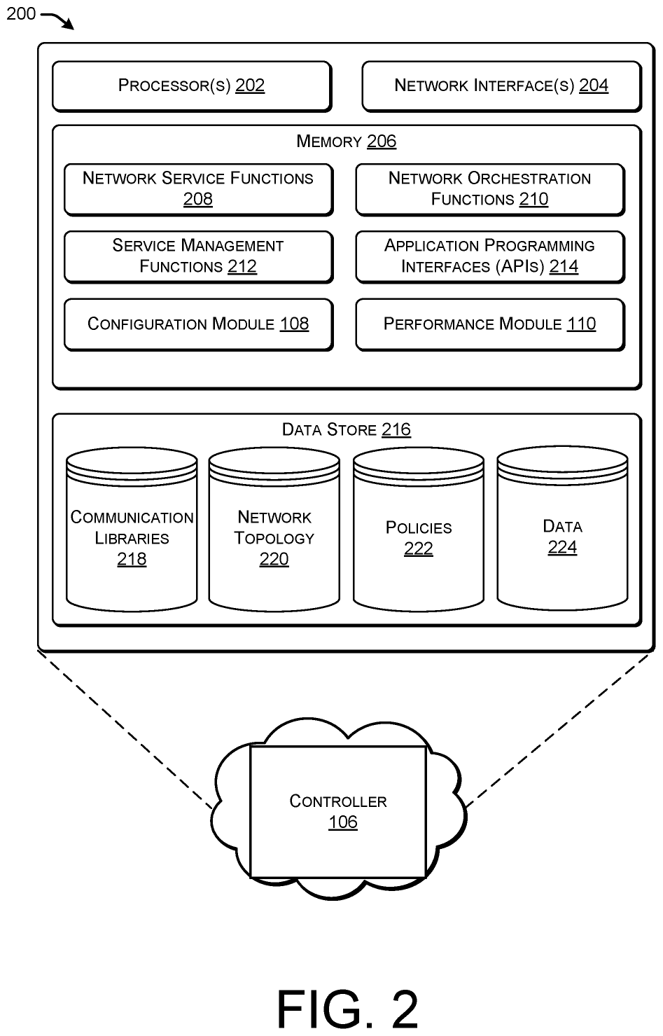

FIG. 2 illustrates a component diagram of an example controller described in FIG. 1. In some instances, one or more of the components of the controller 106 may run on one or more computing devices in, or associated with, the service network(s) 102 (e.g., a single device or a system of devices), system 100, and/or system 100B. In some instances, the controller 106 may be integrated as part of a cloud-based management solution.

Generally, the controller 106 may include a programmable controller that manages some or all of the control plane activities of the service network(s) 102 and manages or monitors the network state using one or more centralized control models.

As illustrated, the controller 106 may include, or run on, one or more hardware processors 202 (processors), one or more devices, configured to execute one or more stored instructions. The processor(s) 202 may comprise one or more cores. Further, the controller 106 may include or be associated with (e.g., communicatively coupled to) one or more network interfaces 204 configured to provide communications with edge device(s) and other devices, and/or other systems or devices in the service network(s) 102 and/or remote from the service network(s) 102. The network interfaces 204 may include devices configured to couple to personal area networks (PANs), wired and wireless local area networks (LANs), wired and wireless wide area networks (WANs), SDCI's, and so forth. For example, the network interfaces 204 may include devices compatible with any networking protocol.

The controller 106 may also include memory 206, such as computer-readable media, that stores various executable components (e.g., software-based components, firmware-based components, etc.). The memory 206 may generally store components to implement functionality described herein as being performed by the controller 106. The memory 206 may store one or more network service functions 208, such as a slicing manager, a topology manager to manage a topology of the service network(s) 102, a host tracker to track what network components are hosting which programs or software, a switch manager to manage switches of the service network(s) 102, a process manager, and/or any other type of function performed by the controller 106.

The controller 106 may further include network orchestration functions 210 stored in memory 206 that perform various network functions, such as resource management, creating and managing network overlays, programmable APIs, provisioning or deploying applications, software, or code to hosts, and/or perform any other orchestration functions. Further, the memory 206 may store one or more service management functions 212 configured to manage the specific services of the service network(s) 102 (configurable), and one or more APIs 214 for communicating with devices in the service network(s) 102 and causing various control plane functions to occur.

Further, the controller 106 may include configuration module 108. As described above, the configuration module 108 may configure one or more node(s) within a service provider network to perform specific hashing behavior(s). The configuration module 108 may further configure the ingress module to create and maintain a TCAM table. The configuration module may further limit the ingress module to using 12 bits of the flow label value when configuring performance measurement session(s).

The controller 106 may include performance module 110. In some examples, the performance module 110 is configured to collect and monitor performance data associated with performance measurement session(s). The performance module 110 may identify when one or more pathway(s) are not in compliance with performance metric(s) and/or come back into compliance with the performance metric(s). In some examples, the performance module 110 may also utilize network data (e.g., topology, policy information, etc.) or any other data described herein. As described above, the performance module may send instruction(s) to the ingress node to perform one or more action(s) (e.g., add entry to TCAM table, use an alternative pathway and/or alternative flow label value, remove entry from TCAM table, start performance measurement session(s), etc.).

The controller 106 may further include a data store 216, such as long-term storage, that stores communication libraries 218 for the different communication protocols that the controller 106 is configured to use or perform. Additionally, the data store 216 may include network topology data 220, such as a model representing the layout of the network components in the service network(s) 102 and/or data indicating available bandwidth, available CPU, delay between nodes, computing capacity, processor architecture, processor type(s), etc. The data store 216 may store policies 222 that include, but are not limited to, AAR policies, SLA policies, security data associated with the network, security policies configured for the network, firewall policies, firewall configuration data, security posture data, and/or compliance policies configured for the network. The data store 216 may store data and models 224 that includes performance data, flow label value(s), pathway(s), telemetry data, network data, and/or any other data described herein.

FIG. 3A illustrates an exemplary encapsulated data packet 300A that may be output by an ingress node of a service provider network.

As illustrated the encapsulated data packet 300A comprises IPv6 header 302. As illustrated, the IPV6 header 302 may include fields corresponding to a source address (SA), destination address (DA), and flow label field(s) 304. In some examples, the SA and/or the DA may correspond to entry and exit points within the service provider network(s). For instance, SA of the IPv6 header 302 may correspond to where the data packet is injected into the service provider network 102 (e.g., such as ingress node 116). The DA may correspond to where the encapsulated data packet 300A is being sent to within the service provider network (e.g., such as an egress node 124, etc.). In some examples, the IPV6 header 302 corresponds to the outer header that is built by an ingress node as part of SRv6 encapsulation. As described above, the flow label value in the flow label field 304 may be computed in a NPU of the ingress node, based on a 5-tuple, or using any other suitable technique.

In the illustrated example, flow label field 304 comprises a fixed header bit that is unset (e.g., “flowlabel [19]: 0”). Accordingly, as described above, the unset value signals to transit node(s) to perform existing hashing techniques on the IPV6 packet. For instance, transit nodes may perform hashing using fields including the external IPv6 encapsulation (e.g., IPv6.SA, IPV6.DA, IPv6.FL, IPv6.NH, etc.), as well as internal headers such as the IPV4 header 306 (e.g., and fields IPV4.SA, IPv4.DA, IPv4.Proto), TCP header and corresponding fields (e.g., a TCP source port, TCP destination port, etc.).

The encapsulated data packet 300A also comprises an IPV4 header 306, includes fields indicating the SA and the DA. In some examples, the SA of the IPV4 header 306 corresponds to where the data packet originated from (e.g., the client device 112, etc.) and the DA of the IPV4 header 306 corresponds to an endpoint (e.g., internet, server, etc.). In some examples, the SA and/or the DA of the IPV4 header may be the same as the SA and/or DA of the IPV6 header 302. The encapsulated data packet 300A may further comprise a TCP header, which may include fields corresponding to a source port and/or a destination port. The encapsulated data packet 300A may include one or more additional fields and/or headers.

FIG. 3B illustrates an exemplary encapsulated data packet 300B that may be output by the ingress node 116. In some examples, the encapsulated data packet 300B may correspond to a customer data packet. In some examples, the encapsulated data packet 300B may correspond to a data flow for which there is a particular SLA requirement (e.g., guaranteed SLA, etc.).

As illustrated the encapsulated data packet 300B comprises IPv6 header 308. As illustrated, the IPV6 header 308 may include fields corresponding to a source address (SA), destination address (DA), and flow label field(s) 310. In some examples, the SA and/or the DA may correspond to entry and exit points within the service provider network(s). For instance, SA of the IPv6 header 308 may correspond to where the data packet is injected into the service provider network 102 (e.g., such as ingress node 116). The DA may correspond to where the encapsulated data packet 300A is being sent to within the service provider network (e.g., such as an egress node 124, etc.). In some examples, the IPV6 header 308 corresponds to the outer header that is built by an ingress node as part of SRv6 encapsulation. As described above, the flow label value in the flow label field 310 may be computed in a NPU of the ingress node, based on a 5-tuple, or using any other suitable technique.

In the illustrated example, flow label field 310 comprises a fixed header bit that is set (e.g., “flowlabel [19]: 1”). Additionally, the flow label field 310 includes entropy information (e.g., flowlabel [18:0]: entropy). In some examples, the FH bit of the flow label field 310 may be set where the ingress node 116 identifies a data flow as requiring a particular SLA (e.g., has the guaranteed SLA, etc.). As described above, the set value signals to transit node(s) to perform the particular hashing techniques on the IPv6 packet that are configured by controller 106. For instance, in contrast to the hashing described for encapsulated data packet 300B, the transit node(s) are configured to perform hashing of encapsulated data packet 300B using one or more fields of the IPV6 header 308 (e.g., one or more of the flow label field 310, IPv6 SA, and/or IPv6 DA). Thus, the remaining fields of the IPV6 header (including the NH, etc.), as well as the fields of the inner IPv4 encapsulated packet(s) (e.g., IPv4 header, TCP, etc.) are masked (e.g., not used) by the transit nodes for the purpose of ECMP hashing.

The encapsulated data packet 300B also comprises an IPV4 header, which includes fields indicating the SA and the DA. In some examples, the SA of the IPV4 header corresponds to where the data packet originated from (e.g., the client device 112, etc.) and the DA of the IPv4 header corresponds to an endpoint (e.g., internet, server, etc.). In some examples, the SA and/or the DA of the IPV4 header may be the same as the SA and/or DA of the IPV6 header 308. The encapsulated data packet 300B may further comprise a TCP header, which may include fields corresponding to a source port and/or a destination port. The encapsulated data packet 300B may include one or more additional fields and/or headers.

FIG. 3C illustrates an exemplary encapsulated probe packet 300C output by an ingress node 116 during a performance measurement session. In some examples, the encapsulated probe packet 300C may be generated based on encapsulated data packet 300B. For instance, where the ingress node 116 and/or controller 106 identifies particular customer data flow(s) as being associated with particular SLA requirements, the controller 106 may instruct the ingress node 116 to configure measurement session(s) for the particular customer data flow(s).

As illustrated the encapsulated probe packet 300C comprises IPv6 header 312, which includes a source address (SA), destination address (DA), and flow label field(s) 314. In some examples, the SA and/or the DA may correspond to entry and exit points within the service provider network(s). For instance, the SA of the IPV6 header 312 may correspond to where the probe packet is injected into the service provider network 102 (e.g., such as ingress node 116). The DA may correspond to where the encapsulated probe packet 300C is being sent to within the service provider network (e.g., such as an egress node 124, etc.). In some examples, the IPV6 header 312 corresponds to the outer header that is built by an ingress node as part of SRv6 encapsulation. As described above, the flow label value in the flow label field 314 may be computed in a NPU of the ingress node, based on a 5-tuple, or using any other suitable technique. In some examples, the flow label value comprises a random value created at probe generation using 20-bits from timestamp (e.g., such as lower 20 bits). In some examples, as part of the SRv6 encapsulation, the flow label value is propagated in NPU from the TWAMP IPV6 header into the SRv6 encapsulation.

In the illustrated example, flow label field 314 comprises a fixed header bit that is set (e.g., “flowlabel [19]: 1”). Additionally, the flow label field 314 includes entropy information 316, which is mapped to the encapsulated customer data packet (e.g., encapsulated data packet 300B), illustrated as “flowlabel [18:0]: same_entropy_as_300B.” As described above, the set value of the fixed header bit signals to transit node(s) to perform the particular hashing techniques on the IPV6 packet that are configured by controller 106. For instance, in contrast to the hashing described for encapsulated data packet 300A, the transit node(s) may be configured to perform hashing of encapsulated data packet 300B using the flow label field 310 of the IPV6 header 308. In this example, the remaining fields of the IPv6 header (including the IPV6 SA, IPV6 DA, IPV6 next header (NH), etc.), as well as the fields of the inner IPv4 encapsulated packet(s) (e.g., IPv4 header, TCP, etc.) are masked (e.g., not used) by the transit nodes for the purpose of ECMP hashing. In some examples, the set value may signal to the transit nodes to perform hashing of encapsulated probe packet 300C using the flow label field 310 and one or more of the IPV6 source address and/or IPv6 destination address of the IPV6 header. In this example, the remaining fields of the IPV6 header (e.g., the next header, etc.), as well as the fields of the inner IPv4 encapsulated packet(s) are masked by the transit nodes for the purpose of ECMP hashing.

Moreover, since the encapsulated probe packet 300C has the same entropy information 316 as encapsulated data packet 300B, the encapsulated probe packet 300C has the same values as the encapsulated data packet 300B that the transit nodes will use to perform ECMP hashing. Accordingly, the encapsulated probe packet 300C may be hashed into the same pathway in the service provider network as encapsulated data packet 300B, thereby enabling the encapsulated probe packet 300C to have the same experience within the service provider network (e.g., traverse the same ECMP pathway(s), etc.). This enables the controller 106 to receive performance data associated with the ECMP pathways and data traffic experience that is more accurate over existing techniques.

The encapsulated probe packet 300C also comprises an IPV4 header, which includes fields indicating the SA and the DA. In some examples, the SA of the IPV4 header corresponds to where the data packet originated from (e.g., the client device 112, etc.) and the DA of the IPv4 header corresponds to an endpoint (e.g., internet, server, etc.). In some examples, the SA and/or the DA of the IPV4 header may be the same as the SA and/or DA of the IPv6 header 312. The encapsulated probe packet 300C may further comprise a UDP header, TWAMP header, and/or any other header(s) and/or field(s).

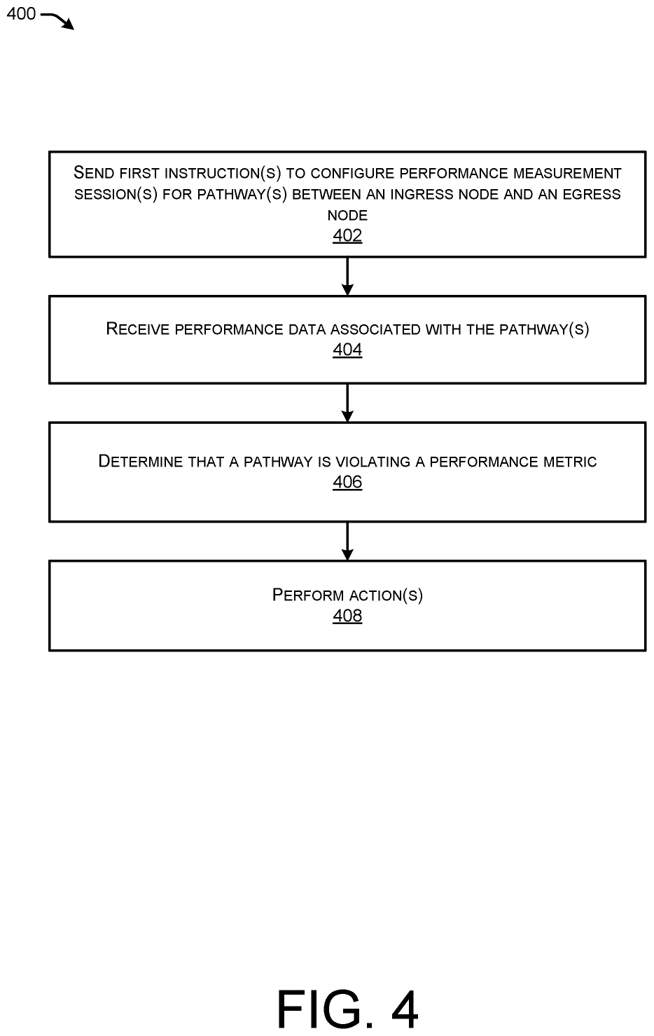

FIG. 4 illustrates a flow diagram of an example system 400 for real-time and selective management of ECMP pathways that are not meeting SLA requirements, associated with the systems described in FIGS. 1-3. In some instances, one or more of the steps of system 400 may be performed by one or more devices (e.g., controller 106, ingress node(s) 116, transit node(s), egress node(s) 124, etc.) that include one or more processors and one or more non-transitory computer-readable media storing computer-executable instructions that, when executed by the one or more processors, cause the one or more processors to perform operations of system 400.

At 402, the system may send first instruction(s) to configure performance measurement session(s) for pathway(s) between an ingress node and an egress node. For instance, the first instruction(s) may identify a particular data flow associated with a particular SLA requirement. In some examples, the first instruction(s) may configure a performance measurement session for a first pathway between the ingress node and the egress node. In some examples, the first instruction(s) are sent using configuration module 108. In some examples, the first instruction(s) may configure a plurality of performance measurement session(s) for a plurality of pathway(s). For instance, the first pathway is one of a plurality of ECMP pathways. The plurality of ECMP pathways may include additional pathways (e.g., such as a second pathway corresponding to an alternative pathway). As described above, each respective pathway may correspond to a respective flow label. In some examples, each respective pathway of the plurality of ECMP pathways corresponds to a respective performance measurement session.

In some examples, prior to sending the first instruction(s), the system may include sending, to a plurality of nodes within the network, third instructions, wherein the third instructions configure each respective node of the plurality of nodes to: receive data packets associated with customer data traffic; and perform encapsulation on each respective data packet of the data packets, wherein the encapsulation includes setting a fixed header bit associated with a flow label header within each of the data packets to a value that indicates the fixed header bit is set.

In some examples, prior to sending the first instruction(s), the system may include sending, to a plurality of nodes within the network, third instructions, wherein the third instructions configure each of the plurality of nodes to: determine that a fixed header bit associated with a flow label header of a data packet comprises a value indicating the fixed header bit is set; based on the fixed header bit being set: mask one or more inner headers of the data packet; mask one or more first fields of an outer header of the data packet, the outer header corresponding to an IPv6 header; and hash the data packet using one or more second fields of the outer header.

In some examples, prior to sending the first instruction(s), the system may include sending, to the ingress node, a third instruction to limit a size of a flow label to less than 20 bits. For instance, the system may configure the ingress node to utilize 12 bits as described above, or any suitable amount of bits for entropy purposes.

In some examples, prior to sending the first instruction(s), the system may include sending, to the ingress node, a third instruction that configures the ingress node to create and store a table, the table comprising one or more entries associated with one or more flow labels corresponding to one or more pathways that violate one or more performance metrics, and wherein the ingress node is configured to compare a third flow label generated for the subsequent data packet to the respective one or more entries and, where a match is identified, identify the second pathway and re-hash the subsequent data packet. For instance, the system may re-hash the subsequent data packet to the second pathway and may verify the alternative hash value is not stored in the table. Where the third flow label is not stored in the table, the system may use the alternative hash value for encapsulation.

At 404, the system may receive performance data associated with the pathway(s). For instance, the system may receive the performance data 136 from egress node(s) 124. In some examples, the performance data is associated with a single measurement session of a single pathway. In some examples, the performance data is associated with multiple measurement sessions of multiple pathways. In some examples, the performance data is received by the performance module 110. The performance data may be received at a first time. For instance, the performance data may be received at time intervals (e.g., ever second, etc.). In some examples, the performance data may comprise telemetry data, network data, etc. In some examples, the performance data may be associated with an IPV6 packet 132 and/or probe packet 138.

At 406, the system may determine that a pathway is violating a performance metric. For instance, the performance metric may correspond to a SLA requirement, AAR policy, quality of service requirement, or any other policy described herein.

At 408, the system may perform action(s). For instance, the system may perform one or more action(s) using performance module 110. In some examples, the one or more action(s) may include identifying a second pathway (e.g., an alternative pathway) as complying with the performance metric. In some examples, the second pathway is identified based on the performance data and/or second performance data received from the egress node that is associated with the respective pathways of the plurality of ECMP pathways.

In some examples, the action(s) may include sending second instruction(s) to the ingress node. For instance, the second instruction may cause the ingress node to generate a new entry in in the table that indicates the first flow label is associated with the first pathway that is violating the performance metric and/or to encapsulate a subsequent data packet that includes the first flow label using a second flow label that corresponds to a second pathway that complies with the performance metric.

In some examples, the system may maintain the pathway that is violating the performance metric and may continue monitoring the pathway. For instance, the one or more action(s) may include receiving, from the egress node and at a second time, second performance data associated with the first pathway. The system may determine, based on the second performance data, that the first pathway complies with the performance metric. The system may send, to the ingress node, a third instruction to remove the entry associated with the first flow label from the table.

In this way, the system may enable a controller to (i) measure the experience of user traffic more accurately and (ii) may steer the traffic of the affected users in real-time from the affected pathway to a different path that does not experience performance degradation. Moreover, by configuring ingress nodes to create and perform a new behavior at the ingress node data plane (e.g., create and maintain the poisoned flow label TCAM table), the system may enable selective and real-time removal of pathways that violate performance metrics and utilization of other pathways, along the same route, that meets performance metrics. The system further provides real-time updates, such that pathway(s) previously unavailable may become available once back in compliance. Moreover, by re-hashing the data packet and/or probe packet and/or using alternative flow label value(s), the system provides improved stability to the service network, as the route of the data packet and/or probe packet is unchanged.

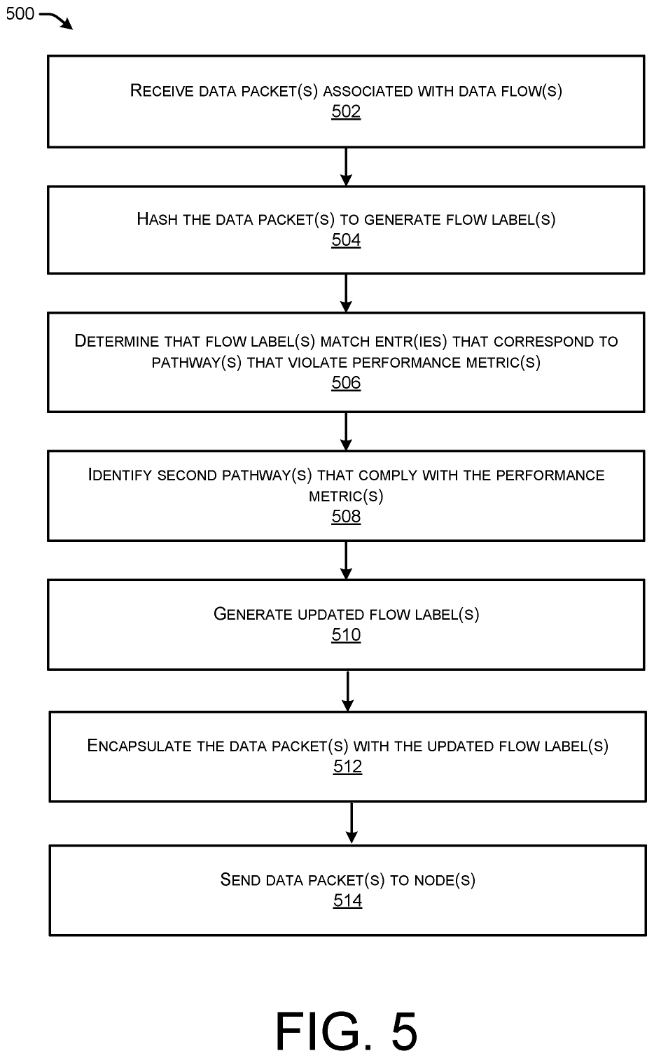

FIG. 5 illustrates a flow diagram of an example system 500 for performing real-time and selective management of ECMP pathways that are not meeting SLA requirements, associated with the systems described in FIGS. 1-4. In some instances, one or more of the steps of system 500 may be performed by one or more devices (e.g., controller 106, ingress node(s) 116, transit node(s), egress node(s) 124, etc.) that include one or more processors and one or more non-transitory computer-readable media storing computer-executable instructions that, when executed by the one or more processors, cause the one or more processors to perform operations of system 500.

At 502, the system may receive data packet(s) associated with data flow(s). For instance, the system may receive data packet(s) 130. In some examples, the data packet(s) 130 may be associated with a data flow that has a particular performance metric (e.g., SLA requirement, quality of service requirement, etc.). In some examples, the data packet(s) 130 may be associated with one or more performance measurement session(s). For instance, the system may receive instruction(s) configuring measurement session(s) for one or more of the data flow(s).

At 504, the system may hash the data packet(s) to generate flow label(s). In some examples, the system may hash the data packet(s) using the outer IPv6 flow label header of the data packet. In some examples, the system may hash the data packet(s) using hashing module 118. As described above, the system may hash the data packet(s) to generate a flow label (e.g., a flow label value) associated with the data packet. As noted above, the flow label may dictate how the data packet(s) are routed within the service provider network(s). For instance, the flow label(s) may be associated with a particular pathway (e.g., ECMP pathway).

At 506, the system may determine that flow label(s) match entr (ies) that correspond to pathway(s) that violate performance metric(s). For instance, the system may determine that the flow label matches a stored flow label associated with an entry in a table maintained by the first node. The stored flow label may indicate the first pathway violates a performance metric. For instance, the system may determine the flow label(s) match one or more entr (ies) using the TCAM module 120. The system may perform a lookup operation in the TCAM table to determine whether one or more flow labels (e.g., hash value) is stored as an entry within the TCAM table. As described above, the TCAM table may store “poisoned flow labels” that represent flow label values associated with pathway(s) that are not performing correctly (e.g., violating a SLA requirement, or other performance issue). As described above, the TCAM table may also store alternative pathway(s) and/or alternative flow label value(s) in association with each respective flow label.

At 508, the system may identify second pathway(s) that comply with the performance metric(s). In some examples, the system may identify a second pathway based on an instruction received from a controller. In some examples, the system may be configured to store alternative pathway(s) in association with each entry. For instance, the table may store a second flow label (e.g., an alternative flow label value) associated with the second pathway in association with the first pathway. As noted above, each of the entries within the table may store associations with different alternative pathway(s).

At 510, the system may generate updated flow label(s). For instance, the system may generate the updated flow label(s) by re-hashing the data packet using the alternative flow label value associated with the second pathway. In some examples, the system may compare the updated flow label(s) to the stored entries of the of the TCAM, to verify that the updated flow label does not match an entry of the TCAM.

In some examples, the system may generate the updated flow label by identifying the second flow label that may be stored in association with the second pathway. In this example, the system may receive instructions from a controller to use the second pathway as the alternative pathway. Accordingly, the system may identify the alternative flow label as the updated flow label.

In some examples, such as where the updated flow label does not match an entry within the TCAM and/or where the system identifies the updated flow label in association with the second pathway, the updated flow label is output to the encapsulation module 122 for use when building the outer IPv6 encapsulation of the data packet.

In some examples, the updated flow label value may correspond to the alternative flow label value. For instance, the system may generate the updated flow label value by outputting an indication to the encapsulation module 122 to use the updated flow label value when encapsulating the data packet (e.g., such that the system may not need to re-hash the data packet).

At 512, the system may encapsulate the data packet(s) with the updated flow label(s). For instance, the system may encapsulate the data packet(s) using encapsulation module 122. In some examples, the encapsulated data packet(s) correspond to IPv6 packet(s) 132 and/or probe packet(s) 138 described above. In some examples, encapsulation of the data packet includes encoding the updated flow label into the outer header of the data packet. In some examples, the encapsulated data packet(s) comprise a fixed header bit 134 that has a set value. As noted above, the set value may indicate to one or more transit nodes to refrain from masking an IPv6 flow label field associated with a load balancing vector and mask all other fields associated with the load balancing vector prior to building load balancing keys used to perform encapsulation of the data packet.

In some examples, the system may build probe packet(s) 138 based on the encapsulated data packet(s). For instance, the system may build probe packet(s) 138 for use during a performance measurement session. In some examples, the probe packet(s) 138 may be built and/or created simultaneously with the encapsulated data packet(s).

At 514, the system may send the data packet(s) to node(s). In some examples, the data packet(s) correspond to encapsulated customer data packet(s) that have a fixed header bit set. In some examples, the data packet(s) correspond to measurement probe packet(s) (e.g., probe packet(s) 138). In some examples, the data packet(s) can be sent through one or more transit node(s) to the egress node 124. In some examples, the data packet(s) and/or probe packet(s) are sent via the updated pathway (e.g., ECMP pathway). Thus, the system may change the pathway the data packet(s) and/or probe packet(s) are sent within between node(s) of the service provider network 102, without changing the routing of the data packet(s) (e.g., data packet(s) are sent through the same transit router(s) as part of shortest path to the egress node 124). Further, the probe packet(s) 138 and the data packet(s) may be sent via the same updated pathway, resulting in measurement of the same experience as the data packet(s).

In this way, the system may steer the traffic of the affected users in real-time from the affected pathway to a different path that does not experience performance degradation in real-time. That is, by configuring hardware of node(s) within the service network to perform specific hashing when a fixed header bit is set, the system may ensure measurement packets and customer traffic are sent via the same pathways. Moreover, by configuring ingress nodes to create and perform a new behavior at the ingress node data plane (e.g., create and maintaining the poisoned flow label TCAM table), the system may enable selective and real-time removal of pathways that violate performance metrics and utilization of other pathways, along the same route, that meets performance metrics. The system further provides real-time updates, such that pathway(s) previously unavailable may become available once back in compliance. Moreover, by re-hashing the data packet and/or probe packet and/or using the alternative flow label(s) for encapsulation, the system provides improved stability to the service network, as the route of the data packet and/or probe packet is unchanged.

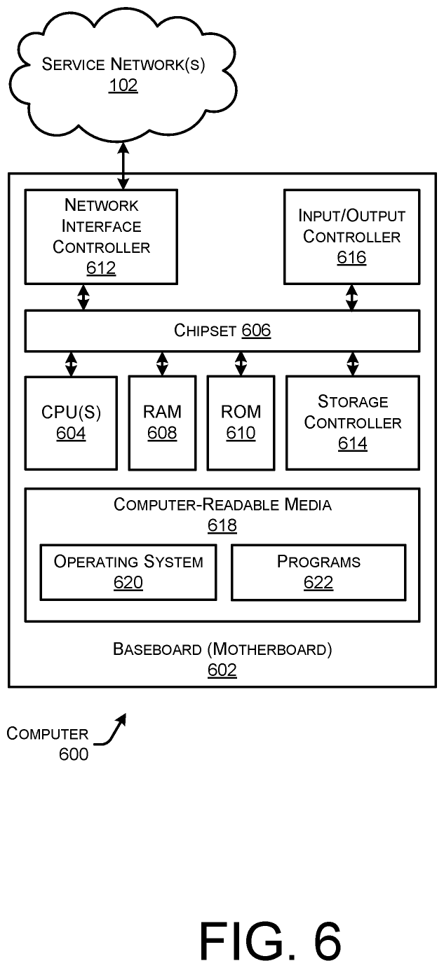

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a controller 106, ingress node(s) 116, transit node(s), egress node(s) 124, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs 604”) operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as service network(s) 102. The chipset 606 can include functionality for providing network connectivity through a NIC 612, such as a gigabit Ethernet adapter. The NIC 612 is capable of connecting the computer 600 to other computing devices over the service network(s) 102. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the controller 106, ingress node(s) 116, transit node(s), egress node(s) 124, and/or any components included therein, may be supported by one or more devices similar to computer 600. Stated otherwise, some or all of the operations performed by the controller 106, ingress node(s) 116, transit node(s), egress node(s) 124, and/or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a controller 106 and/or any other device. The computer 600 may include one or more hardware processors (processor(s), such as CPUs 604) configured to execute one or more stored instructions. The processor(s) may comprise one or more cores. Further, the computer 600 may include one or more network interfaces configured to provide communications between the computer 600 and other devices, such as the communications described herein as being performed by the controller 106 and/or any other device. The network interfaces may include devices configured to couple to personal area networks (PANs), wired and wireless local area networks (LANs), wired and wireless wide area networks (WANs), SDWANs, and so forth. For example, the network interfaces may include devices compatible with Ethernet, Wi-Fi™, and so forth.

The programs 622 may comprise any type of programs or processes to perform the techniques described in this disclosure. For instance, the programs 622 may cause the computer 600 to perform techniques including sending, to an ingress node and an egress node within the network, a first instruction to configure a performance measurement session for a first pathway between the ingress node and the egress node; receiving, from the egress node and at a first time, first performance data associated with the first pathway, the first performance data including a first flow label; determining, based at least in part on the first performance data, that the first pathway is violating a performance metric; and sending, to the ingress node, a second instruction to encapsulate a subsequent data packet that includes the first flow label using a second flow label that corresponds to a second pathway that complies with the performance metric.

Additionally, the programs 622 may cause the computer 600 to perform techniques including receiving, by a first node of a network and via a first pathway, a data packet associated with a customer data flow; hashing, by the first node, an outer header of the data packet to generate a flow label associated with the data packet; determining, by the first node, that the flow label matches a stored flow label associated with an entry in a table maintained by the first node, the stored flow label indicating the first pathway violates a performance metric; based at least in part on determining that the flow label matches the stored flow label: identifying a second pathway that complies with the performance metric; and identifying an updated flow label; encoding, by the first node, the updated flow label into the outer header of the data packet; and sending, by the first node and to a second node, the data packet via the second pathway.

In this way, the computer 600 may (i) measure the experience of user traffic more accurately and (ii) may steer the traffic of the affected users in real-time from the affected pathway to a different path that does not experience performance degradation. That is, by configuring hardware of node(s) within the service network to perform specific hashing when a fixed header bit is set, the computer 600 may ensure measurement packets and customer traffic are sent via the same pathways. Moreover, by configuring ingress nodes to create and perform a new behavior at the ingress node data plane (e.g., create and maintaining the poisoned flow label TCAM table), the computer 600 may enable selective and real-time removal of pathways that violate performance metrics and utilization of other pathways, along the same route, that meets performance metrics.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method implemented by a controller of a network, the method comprising:
sending, to an ingress node and an egress node within the network, a first instruction to configure a performance measurement session for a first pathway between the ingress node and the egress node;
receiving, from the egress node and at a first time, first performance data associated with the first pathway, the first performance data including a first flow label;
determining, based at least in part on the first performance data, that the first pathway is violating a performance metric; and
sending, to the ingress node, a second instruction to encapsulate a subsequent data packet that includes the first flow label using a second flow label that corresponds to a second pathway that complies with the performance metric.

2. The method of claim 1, wherein the second instruction further causes the ingress node to create a new entry in a table that indicates the first flow label corresponds to the first pathway that violates the performance metric, the method further comprising:
receiving, from the egress node and at a second time, second performance data associated with the first pathway;
determining, based on the second performance data, that the first pathway complies with the performance metric; and
sending, to the ingress node, a third instruction to remove the new entry associated with the first flow label from the table.

3. The method of claim 1, wherein:
the first pathway is one of a plurality of ECMP pathways, the plurality of ECMP pathways including the second pathway;
the performance measurement session is one of a plurality of performance measurement sessions; and
each respective pathway of the plurality of ECMP pathways corresponds to a respective performance measurement session.

4. The method of claim 3, further comprising:
receiving, from the egress node, second performance data associated with the respective pathways of the plurality of ECMP pathways; and
identifying, based on the second performance data, the second pathway as complying with the performance metric.

5. The method of claim 1, wherein prior to sending the first instruction, the method further comprises:
sending, to a plurality of nodes within the network, third instructions, wherein the third instructions configure each respective node of the plurality of nodes to:
receive data packets associated with customer data traffic; and
perform encapsulation on each respective data packet of the data packets, wherein the encapsulation includes setting a fixed header bit associated with a flow label header within each of the data packets to a value that indicates the fixed header bit is set.

6. The method of claim 1, wherein prior to sending the first instruction, the method further comprises:
sending, to a plurality of nodes within the network, third instructions, wherein the third instructions configure each of the plurality of nodes to:
determine that a fixed header bit associated with a flow label header of a data packet comprises a value indicating the fixed header bit is set; and
based on the fixed header bit being set:
mask one or more inner headers of the data packet;
mask one or more first fields of an outer header of the data packet, the outer header corresponding to an IPV6 header; and
hash the data packet using one or more second fields of the outer header.

7. The method of claim 1, wherein prior to sending the first instruction, the method further comprises sending, to the ingress node, a third instruction to limit a size of a flow label to less than 20 bits.

8. The method of claim 1, wherein prior to sending the first instruction, the method further comprises:
sending, to the ingress node, a third instruction that configures the ingress node to create and store a table, the table comprising one or more entries associated with one or more flow labels corresponding to one or more pathways that violate one or more performance metrics, and
wherein the ingress node is configured to compare a third flow label generated for the subsequent data packet to the respective one or more entries and, where a match is identified, identify the second pathway and re-hash the subsequent data packet.

9. The method of claim 8, wherein the second instruction further causes the ingress node to generate a new entry in in the table that indicates the first flow label is associated with the first pathway that is violating the performance metric.

10. A system comprising:
one or more processors; and
one or more computer-readable media storing instructions that, when executed by the one or more processors, cause the one or more processors to perform operations comprising:
sending, to an ingress node and an egress node within a network, a first instruction to configure a performance measurement session for a first pathway between the ingress node and the egress node;
receiving, from the egress node and at a first time, first performance data associated with the first pathway, the first performance data including a first flow label;
determining, based at least in part on the first performance data, that the first pathway is violating a performance metric; and
sending, to the ingress node, second instructions to (i) generate an entry in memory associated with the first flow label that indicates the first flow label corresponds to the first pathway that violates the performance metric and (ii) when a subsequent data packet includes the first flow label, encapsulate the subsequent data packet using a second flow label corresponding to a second pathway that complies with the performance metric.

11. The system of claim 10, the operations further comprising:
receiving, from the egress node and at a second time, second performance data associated with the first pathway;
determining, based on the second performance data, that the first pathway is in compliance with the performance metric; and
sending, to the ingress node, a third instruction to remove the entry associated with the first flow label from the memory.

12. The system of claim 10, wherein:
the first pathway is one of a plurality of ECMP pathways, the plurality of ECMP pathways including the second pathway;
the performance measurement session is one of a plurality of performance measurement sessions; and
each respective pathway of the plurality of ECMP pathways corresponds to a respective performance measurement session.

13. The system of claim 12, the operations further comprising:
receiving, from the egress node, second performance data associated with respective pathways of the plurality of ECMP pathways; and
identifying, based on the second performance data, the second pathway as complying with the performance metric.

14. The system of claim 10, wherein prior to sending the first instruction, the operations further comprise:
sending, to a plurality of nodes within the network, third instructions, wherein the third instructions configure each respective node of the plurality of nodes to:
receive data packets associated with customer data traffic; and
perform encapsulation on each respective data packet of the data packets, wherein the encapsulation includes setting a fixed header bit associated with a flow label header within each of the data packets to a value that indicates the fixed header bit is set.

15. The system of claim 10, wherein prior to sending the first instruction, the operations further comprise:
sending, to a plurality of nodes within the network, third instructions, wherein the third instructions configure each of the plurality of nodes to:
determine that a fixed header bit associated with a flow label header of a data packet comprises a value indicating the fixed header bit is set; and
based on the fixed header bit being set:
masking one or more inner headers of the data packet;
masking one or more first fields of an outer header of the data packet, the outer header corresponding to an IPV6 header; and
hashing the data packet using one or more second fields of the outer header.

16. The system of claim 10, wherein prior to sending the first instruction, the operations further comprise: sending, to the ingress node, a third instruction to limit a size of a flow label to less than 20 bits.

17. The system of claim 10, wherein prior to sending the first instruction, the operations further comprise:
sending, to the ingress node, a third instruction that configures the ingress node to create and store a table, the table comprising one or more entries associated with one or more flow labels corresponding to one or more pathways that violate one or more performance metrics, and
wherein the ingress node is configured to compare a subsequent flow label generated for the subsequent data packet to the respective one or more entries and, where a match is identified, identify the second pathway and re-hash the subsequent data packet.

18. The system of claim 10, wherein the performance metric corresponds to a service level agreement requirement of the first pathway.

19. A method comprising:
receiving, by a first node of a network and via a first pathway, a data packet associated with a customer data flow;
hashing, by the first node, an outer header of the data packet to generate a flow label associated with the data packet;
determining, by the first node, that the flow label matches a stored flow label associated with an entry in a table maintained by the first node, the stored flow label indicating the first pathway violates a performance metric;
based at least in part on determining that the flow label matches the stored flow label:
identifying a second pathway that complies with the performance metric; and
identify an updated flow label corresponding to the second pathway;
encoding, by the first node, the updated flow label into the outer header of the data packet; and
sending, by the first node and to a second node, the data packet via the second pathway.

20. The method of claim 19, wherein the updated flow label further includes a fixed header bit that comprises a set value that indicates to transit nodes within the network to:
refrain from masking one or more IPv6 header fields associated with a load balancing vector; and
mask one or more other fields associated with the load balancing vector prior to building load balancing keys used to perform encapsulation of the data packet.
